(19) United States
(12) Patent Application Publication
(10) Pub. No.: US 2025/0224092 A1
(43) Pub. Date: Jul. 10, 2025

(54) VEHICLE LAMP

(71) Applicant: KOITO MANUFACTURING CO., LTD., Tokyo (JP)

(72) Inventor: Shohei Tada, Shizuoka (JP)

(73) Assignee: KOITO MANUFACTURING CO., LTD., Tokyo (JP)

(21) Appl. No.: 18/852,864

(22) PCT Filed: Mar. 22, 2023
(86) PCT No.: PCT/JP2023/011292

§ 371 Date: Sep. 30, 2024

(30) Foreign Application Priority Data
Mar. 31, 2022 (JP) 2022-060196

(51) Int. Cl. F21S 41/663; F21S 41/255; F21S 41/36; F21S 41/40; F21S 45/47; F21W 102/135; F21Y 103/10; F21Y 115/10

(52) U.S. Cl. CPC F21S 41/663; F21S 41/255; F21S 41/36; F21S 41/40; F21S 45/47; F21W 2102/135; F21Y 2103/10; F21Y 2115/10

(57) ABSTRACT

A vehicle front lamp is configured to be mounted on a vehicle, and includes a plurality of optical systems. Each of the plurality of optical systems includes a light emitting element and an inner lens disposed on a front side relative to the light emitting element. The plurality of inner lenses are integrated.

### TECHNICAL FIELD

The present disclosure relates to a vehicle lamp to be mounted on a vehicle.

Techniques relating to a vehicle lamp are being developed in the related art. For example, a vehicle lamp disclosed in Patent Literature 1 is a front lamp for a two-wheeled vehicle, which includes a first lamp unit that forms a high-beam distribution pattern, a second lamp unit that forms a low-beam distribution pattern, and a panel member surrounding the first lamp unit and the second lamp unit. The first lamp unit and the second lamp unit have separate inner lenses.

### CITATION LIST

### Patent Literature

Patent Literature 1: JP2015-076364A

### SUMMARY OF INVENTION

### Technical Problem

As in the vehicle lamp described in Patent Literature 1, a lamp including a plurality of inner lenses tends to have an increased number of components.

An object of the present disclosure is to provide a vehicle lamp that can achieve a reduced number of components, reduced cost, and facilitated assembly.

### Solution to Problem

A vehicle lamp according to an aspect of the present disclosure is a vehicle front lamp configured to be mounted on a vehicle, the vehicle front lamp including a plurality of optical systems, each of the plurality of optical systems including a light emitting element and an inner lens disposed on a front side relative to the light emitting element. The plurality of inner lenses are integrated.

### Advantageous Effects of Invention

According to the present disclosure, it is possible to achieve a reduced number of components, reduced cost, and facilitated assembly.

### BRIEF DESCRIPTION OF DRAWINGS

FIG. 1 is a front perspective view illustrating configurations of a vehicle lamp according to an embodiment of the present disclosure.

FIG. 2 is an exploded perspective view illustrating detailed configurations of the vehicle lamp illustrated in FIG. 1.

FIG. 3 is an enlarged view illustrating a detailed configuration of a part of an intermediate member illustrated in FIG. 2.

FIG. 4 illustrates a path of light reflected by a reflecting portion among light emitted from a light emitting element illustrated in FIG. 3.

FIG. 5 illustrates a region illuminated with light reflected by the reflecting portion illustrated in FIG. 4.

FIG. 6 illustrates a path of light passing through a light diffusing portion of an inner lens among light emitted from the light emitting element illustrated in FIG. 3.

### DESCRIPTION OF EMBODIMENTS

### Overall Schematic Configurations

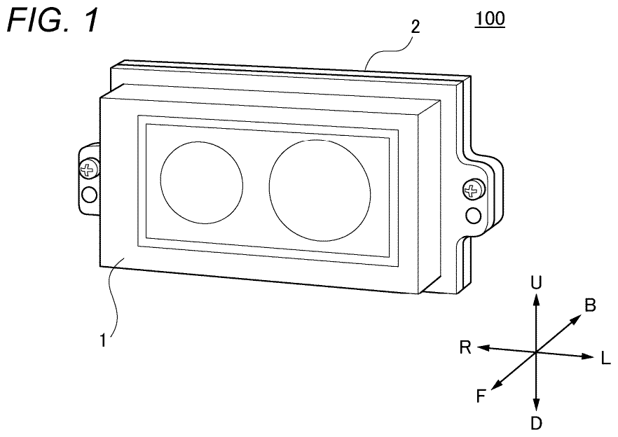

The present disclosure will be described with reference to the drawings. FIG. 1 is a front perspective view illustrating configurations of a vehicle lamp 100 according to an embodiment of the present disclosure.

Referring to FIG. 1, the vehicle lamp 100 is a low-beam and high-beam front lamp to be mounted on a vehicle such as a motorcycle. The vehicle lamp 100 includes an outer lens 1 and a heat sink 2 to which the outer lens 1 is attached.

In this example, a direction of an arrow F illustrated in FIG. 1 is “front”, and a direction of an arrow B is “rear”. A direction of an arrow R illustrated in FIG. 1 is “right”, and a direction of an arrow Lis “left”. A direction of an arrow U illustrated in FIG. 1 is “upper”, and a direction of an arrow D is “lower”.

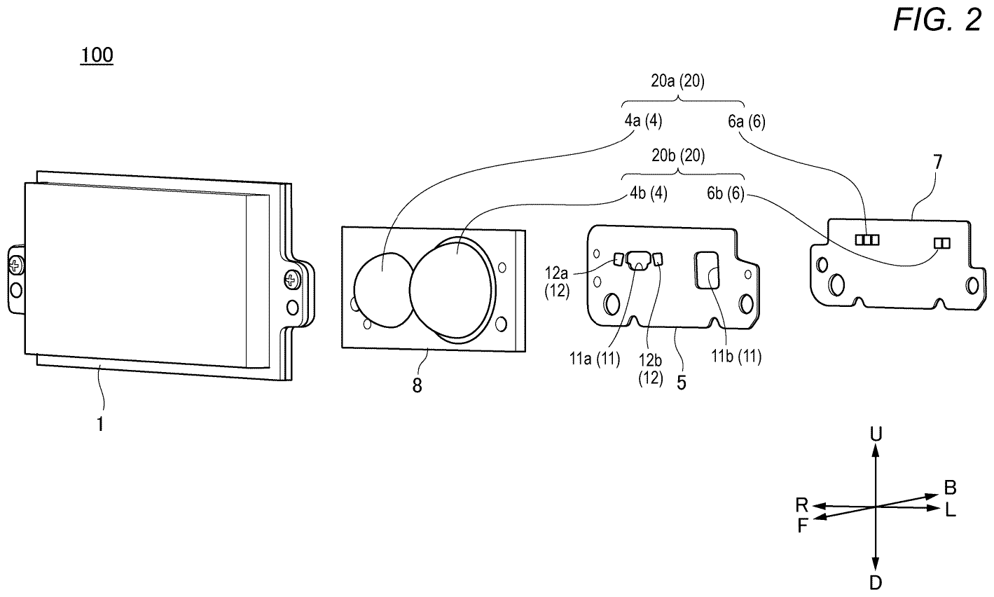

FIG. 2 is an exploded perspective view illustrating detailed configurations of the vehicle lamp 100 illustrated in FIG. 1. FIG. 2 does not illustrate the heat sink 2 illustrated in FIG. 1. Referring to FIGS. 1 and 2, the vehicle lamp 100 includes a plurality of optical systems 20 in addition to the outer lens 1 and the heat sink 2.

Specifically, the vehicle lamp 100 includes, for example, as the optical system 20, a first optical system 20a that forms a low-beam distribution pattern including a cutoff line and a second optical system 20b that forms a high-beam distribution pattern. The first optical system 20a and the second optical system 20b are arranged, for example, side by side in a left-right direction.

More specifically, the vehicle lamp 100 further includes inner lenses 4a and 4b, an intermediate member 5, light emitting elements 6a and 6b, and a substrate 7. Hereinafter, each of the inner lenses 4a and 4b is also referred to as an “inner lens 4”. Each of the light emitting elements 6a and 6b is also referred to as a “light emitting element 6”.

The outer lens 1, the inner lens 4, the intermediate member 5, the light emitting element 6, and the substrate 7 are arranged in this order from a front side. The heat sink 2 illustrated in FIG. 1 is disposed on a rear side relative to the substrate 7. The inner lens 4a and the light emitting element 6a are included in the first optical system 20a. The inner lens 4b and the light emitting element 6b are included in the second optical system 20b.

The light emitting element 6 is, for example, a white light emitting diode, and has a rectangular light emitting surface. The light emitting surface of the light emitting element 6 is provided on a front side, and a rear surface of the light emitting element 6 is supported by the substrate 7. The substrate 7 is supported by the heat sink 2 illustrated in FIG. 1.

The intermediate member 5 is formed with an opening 11 for each optical system. That is, the intermediate member 5 is formed with, as the opening 11, an opening 11a allowing light from the light emitting element 6a to enter the inner lens 4a and an opening 11b allowing light from the light emitting element 6b to enter the inner lens 4b.

The intermediate member 5 further includes reflecting portions 12a and 12b that reflect light from the light emitting element 6a toward the inner lens 4a in a vicinity of the opening 11a. Hereinafter, each of the reflecting portions 12a and 12b is also referred to as a “reflecting portion 12”. Details of the reflecting portion 12 will be described later.

The inner lens 4 is, for example, a projection lens. Specifically, the inner lens 4 is a convex lens having a rear surface, which is an incident surface, being a flat surface and a front surface, which is an emitting surface, being curved and protruding forward. The inner lens 4a refracts light from the light emitting element 6a, and the inner lens 4b refracts light from the light emitting element 6b. The inner lens 4a and the inner lens 4b are formed of the same material and are integrated.

More specifically, for example, the vehicle lamp 100 further includes a plate-shaped coupling portion 8 formed of the same material as the inner lenses 4a and 4b. The front surfaces of the inner lenses 4a and 4b protrude to a front side relative to the coupling portion 8. The rear surfaces of the inner lenses 4a and 4b are formed in the same plane as a rear surface of the coupling portion 8.

The intermediate member 5 is not limited to the configuration of having an opening for each optical system, and may have, for example, one opening coupling the opening 11a and the opening 11b. However, in this case, light from the light emitting element 6a may enter the inner lens 4b, and light from the light emitting element 6b may enter the inner lens 4a. For this reason, the intermediate member 5 preferably has an opening for each optical system.

### Details of Reflecting Portions of Intermediate Member

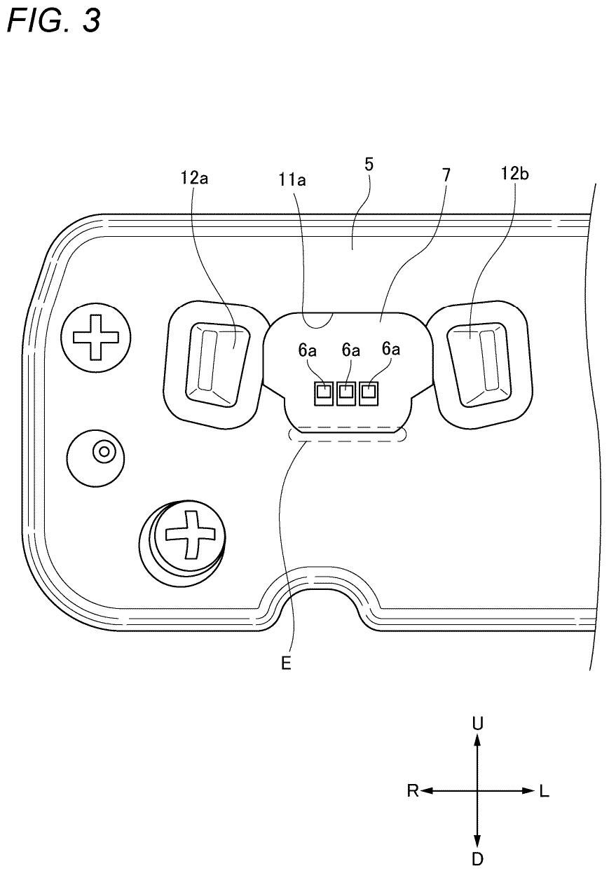

FIG. 3 is an enlarged view illustrating a detailed configuration of a part of an intermediate member illustrated in FIG. 2. FIG. 3 illustrates a part of the intermediate member 5, the light emitting element 6a, and a part of the substrate 7 as viewed from a front side.

Referring to FIG. 3, the light emitting element 6a and a part of the substrate 7 are exposed from the opening 11a of the intermediate member 5. The reflecting portions 12a and 12b are provided respectively on an upper right side and an upper left side relative to the light emitting element 6a on a front surface of the intermediate member 5. FIG. 3 illustrates three light emitting elements 6a, and the number of light emitting elements 6a may be one, two, or four or more.

More specifically, the intermediate member 5 is provided with a region E for blocking unnecessary light toward a lower side relative to the low-beam distribution pattern. Specifically, the region E is a part in a vicinity of a lower side of the opening 11a of the intermediate member 5. The reflecting portion 12 is preferably provided in a region other than the region E. The cutoff line is formed by refraction of light incident on a prescribed region of the inner lens 4a. The reflecting portion 12 is preferably disposed to be avoided from existing on a path of light that forms the cutoff line.

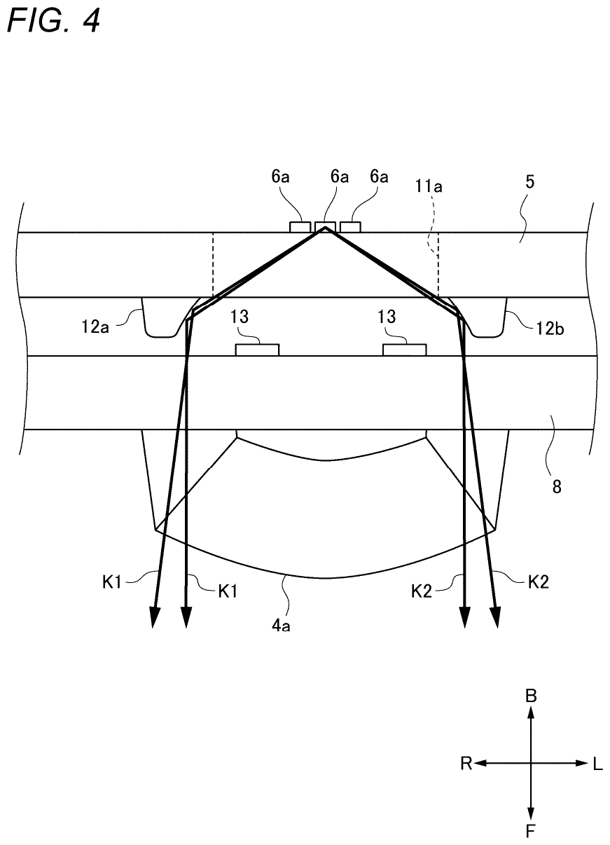

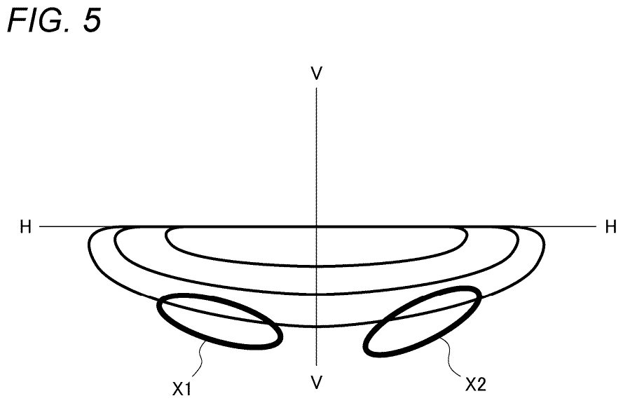

FIG. 4 illustrates a path of light reflected by a reflecting portion among light emitted from a light emitting element illustrated in FIG. 3. FIG. 4 illustrates a part of the intermediate member 5, the light emitting element 6a, the inner lens 4a, and a part of the coupling portion 8 as viewed from above. FIG. 5 illustrates a region illuminated with light reflected by the reflecting portion illustrated in FIG. 4. FIG. 5 illustrates a road surface forward of a vehicle as viewed from a vehicle side.

Referring to FIGS. 4 and 5, among light from the light emitting element 6a, light reaching the reflecting portion 12a provided on the upper right side relative to the light emitting element 6a is reflected by the reflecting portion 12a and enters the inner lens 4a as indicated by arrows K1. Then, as illustrated in FIG. 5, the light illuminates a right region X2 on the road surface in a vicinity and forward of the vehicle.

Light reaching the reflecting portion 12b provided on the upper left side relative to the light emitting element 6a is reflected by the reflecting portion 12b and enters the inner lens 4a as indicated by arrows K2 in FIG. 4. Then, as illustrated in FIG. 5, the light illuminates a left region X1 on the road surface in the vicinity and forward of the vehicle. Accordingly, visibility on the road surface in the vicinity and forward of the vehicle can be improved.

Among the light from the light emitting element 6a, the light reaching the reflecting portion 12a provided on the upper right side relative to the light emitting element 6a may illuminate the left region X1 on the road surface in the vicinity of the vehicle, and the light reaching the reflecting portion 12b provided on the upper left side relative to the light emitting element 6a may illuminate the right region X2 on the road surface in the vicinity of the vehicle.

Alternatively, the present disclosure is not limited to the configuration in which one reflecting portion 12 is provided on each of the upper right side and the upper left side relative to the light emitting element 6a, and the reflecting portion 12 may be provided on any one of the upper right side and the upper left side relative to the light emitting element 6a, or provided in other positions. The number of reflecting portions 12 may be one or three or more. The intermediate member 5 may not include the reflecting portion 12.

### Details of light diffusing portions of Inner Lens

Referring again to FIG. 4, the inner lens 4a includes light diffusing portions 13 that diffuse light emitted from the light emitting element 6a to an incident surface of the light, that is, a part of the rear surface. The light diffusing portion 13 is preferably disposed to be avoided from existing on the path of light that forms the cutoff line. The light diffusing portion 13 may be subjected to, for example, an embossing treatment or a frost treatment. A block-shaped member or the like may be provided as the light diffusing portion 13.

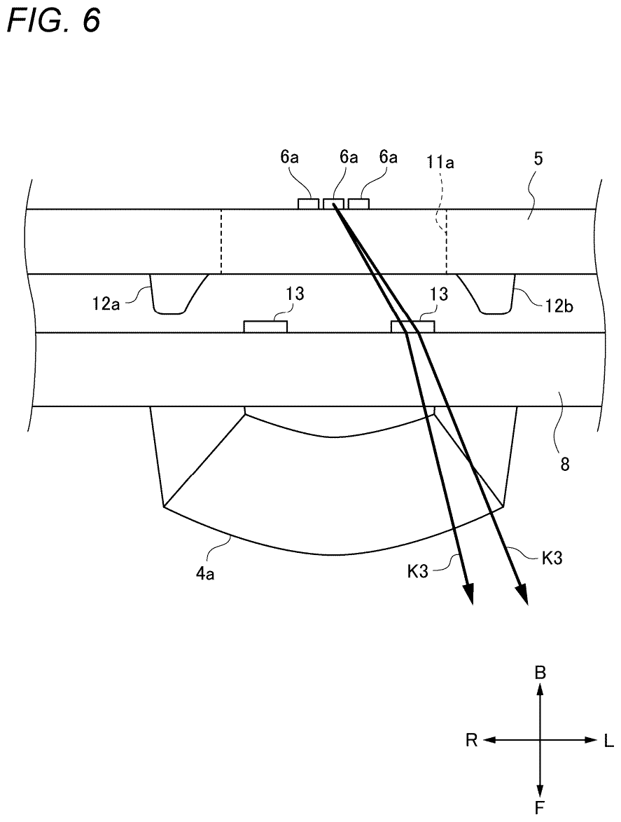

FIG. 6 illustrates a path of light passing through a light diffusing portion of an inner lens among light emitted from the light emitting element illustrated in FIG. 3. Similar to FIG. 4, FIG. 6 illustrates a part of the intermediate member 5, the light emitting element 6a, the inner lens 4a, and a part of the coupling portion 8 as viewed from above.

Referring to FIG. 6, among light from the light emitting element 6a, light reaching the light diffusing portion 13 is diffused by the light diffusing portion 13, enters the inner lens 4a, and is emitted from the inner lens 4a, as indicated by arrows K3. Accordingly, direct light from the light emitting element 6a can be effectively diffused and unevenness of light in an illumination region can be further reduced.

Further, a step (not illustrated) may be provided on the incident surface of the inner lens 4a on a lower side relative to the light emitting element 6a in a front view of the vehicle lamp 100. In this case, among the light from the light emitting element 6a, light reaching the step is reflected by the step and is emitted forward and upward from the inner lens 4a. Accordingly, the light can illuminate a signboard or the like located forward and upward of the vehicle on which the vehicle lamp 100 is mounted. Similar to the light diffusing portion 13, the step is preferably disposed to be avoided from existing on the path of light that forms the cutoff line.

The light diffusing portion 13 is not limited to the configuration of diffusing direct light emitted from the light emitting element 6a as illustrated in FIG. 6. For example, the light diffusing portion 13 may diffuse light reflected by the reflecting portion 12.

The first optical system 20a and the second optical system 20b are not limited to respectively forming the low-beam distribution pattern and the high-beam distribution pattern. For example, both the first optical system 20a and the second optical system 20b may form a low-beam distribution pattern. In this case, the reflecting portion 12 is preferably provided not only in the vicinity of the opening 11a of the intermediate member 5 but also in a vicinity of the opening 11b. In this case, the light diffusing portion 13 preferably diffuses light from the light emitting element 6b not only on the incident surface of the inner lens 4a but also on the incident surface of the inner lens 4b.

The vehicle lamp 100 is not limited to the configuration of including two optical systems, and may include three or more optical systems. A plurality of optical systems are not limited to being arranged side by side in the left-right direction, and may be provided side by side in an upper-lower direction, for example. The vehicle lamp 100 is not limited to the configuration of including the intermediate member 5, and may not include the intermediate member 5.

As described above, the vehicle lamp 100 according to the embodiment of the present disclosure includes a plurality of optical systems 20, each of the plurality of optical systems 20 includes the light emitting element 6 and the inner lens 4 disposed on a front side relative to the light emitting element 6, and the plurality of inner lenses 4 are integrated. With such a configuration, compared to a case in which the inner lenses 4 are separately provided for each optical system 20, the number of components can be reduced, cost can be reduced, and assembly can be facilitated.

In the vehicle lamp 100 according to the embodiment of the present disclosure, at least one of the plurality of inner lenses 4 includes the light diffusing portion 13 on a part of an incident surface on which the light from the light emitting element 6 is incident, and the light diffusing portion 30 is configured to diffuse the light. With such a configuration, direct light from the light emitting element 6 can be effectively diffused and unevenness of light in an illumination region can be further reduced.

In the vehicle lamp 100 according to the embodiment of the present disclosure, the substrate 7 supports the light emitting element 6. The intermediate member 5 is disposed between the substrate 7 and the inner lens 4. The intermediate member 5 includes the reflecting portion 12 configured to reflect light from the light emitting element 6a toward the inner lens 4a. The reflecting portion 12 is provided on at least one of the upper right side and the upper left side relative to the light emitting element 6a. With such a configuration, at least one of a left region and a right region on the road surface in the vicinity and forward of the vehicle is illuminated by appropriate light, and visibility on the road surface in the vicinity and forward of the vehicle can be further improved.

In the vehicle lamp 100 according to the embodiment of the present disclosure, the intermediate member 5 is formed with, for each optical system 20, the opening 11 for allowing the light from the light emitting element 6 to enter the inner lens 4. With such a configuration, the intermediate member 5 can not only reflect the light from the light emitting element 6 toward the inner lens 4 by the reflecting portion 12, but also prevent the light from the light emitting element 6 from entering the inner lens 4 not corresponding to the light emitting element 6. As described above, the configuration in which the plurality of inner lenses 4 are integrated is particularly effective.

In the vehicle lamp 100 according to the embodiment of the present disclosure, the light emitting element 6 and the inner lens 4 are provided in the optical system 20 to form a light distribution pattern including a cutoff line. The reflecting portion 12 in the intermediate member 5 is disposed to be avoided from existing on the path of light forming the cutoff line. With such a configuration, visibility on the road surface in the vicinity and forward of the vehicle can be further improved, and the cutoff line can be prevented from being not clear.

Although the embodiment of the present disclosure is described above, it is needless to say that the technical scope of the present disclosure should not be construed as being limited by the description of the embodiment. It should be understood by a person skilled in the art that the present embodiment is merely an example, and that various modifications of the embodiment are possible within the scope of the inventions described in the claims. The technical scope of the present disclosure is determined based on the scope of the inventions described in the claims and an equivalent scope thereof.

The present application is based on a Japanese patent application No. 2022-060196 filed on Mar. 31, 2022, and contents thereof are incorporated herein by reference.

1. A vehicle front lamp configured to be mounted on a vehicle, the vehicle front lamp comprising:
a plurality of optical systems, each of the plurality of optical systems comprising a light emitting element and an inner lens disposed on a front side relative to the light emitting element,
wherein the plurality of inner lenses are integrated.

2. The vehicle front lamp according to claim 1, wherein at least one of the plurality of inner lenses comprises a light diffusing portion on a part of an incident surface on which light from the light emitting element is incident, the light diffusing portion being configured to diffuse the light.

3. The vehicle front lamp according to claim 1, further comprising:
a substrate supporting the light emitting element; and
an intermediate member disposed between the substrate and the inner lens,
wherein the intermediate member comprises a reflecting portion configured to reflect light from the light emitting element toward the inner lens, and
wherein the reflecting portion is provided on at least one of an upper right side and an upper left side relative to the light emitting element.

4. The vehicle front lamp according to claim 3, wherein the intermediate member is formed with, for each of the optical systems, an opening allowing the light from the light emitting element to enter the inner lens.

5. The vehicle front lamp according to claim 3,
wherein in each of the optical systems, the light emitting element and the inner lens are disposed to form at least a light distribution pattern including a cutoff line, and
wherein the reflecting portion provided on the intermediate member is disposed to be avoided from existing on a path of light forming the cutoff line.

6. The vehicle front lamp according to claim 2, further comprising:
a substrate supporting the light emitting element; and
an intermediate member disposed between the substrate and the inner lens,
wherein the intermediate member comprises a reflecting portion configured to reflect light from the light emitting element toward the inner lens, and
wherein the reflecting portion is provided on at least one of an upper right side and an upper left side relative to the light emitting element.

7. The vehicle front lamp according to claim 4,
wherein in each of the optical systems, the light emitting element and the inner lens are disposed to form at least a light distribution pattern including a cutoff line, and
wherein the reflecting portion provided on the intermediate member is disposed to be avoided from existing on a path of light forming the cutoff line.
